(19) United States
(12) Patent Application Publication
(10) Pub. No.: US 2015/0278749 A1
(43) Pub. Date: Oct. 1, 2015

(54) VIRTUAL PERSONAL ASSISTANT IN MESSENGER

(71) Applicant: International Business Machines Corporation, Armonk, NY (US)

(72) Inventors: Ishfak F. Bhagat, Pune (IN); Sujata S. Indalkar, Pune (IN)

(73) Assignee: International Business Machines Corporation, Armonk, NY (US)

(21) Appl. No.: 14/228,418

(22) Filed: Mar. 28, 2014

(51) Int. Cl. G06Q 10/06; G06F 17/30

(52) U.S. Cl. CPC G06Q 10/063114; G06F 17/30424

(57) ABSTRACT

A method for generating a status report based on at least one status data update from a task owner, wherein the status data update is associated with a task assigned to the task owner is provided. The method may include querying the at least one task owner for at least one status data update associated with the at least one assigned task, wherein the querying is performed by a virtual personal assistant (VPA) associated with an on-line messaging environment. The method may also include recording the at least one status data update in a repository based on the querying by the VPA. The method may further include generating the status report based on the recorded at least one status data update.

### FIELD OF THE INVENTION

The present invention relates generally to the field of computing, and more particularly to real time communications.

### BACKGROUND

Regular status reports are becoming a common occurrence in the workplace. Such status reports may require regular status updates by team members to their manager. The regular status updates may increase communication between management and their teams. For example, an employee may be asked to report weekly status updates to their manager regarding a specific task that was assigned to the employee. The status report enables the manager to keep track of the status of assigned tasks and aides with workflow management. The weekly status reporting may be performed by various methods, such as by documenting tasks at a personal level daily and then consolidating it to send to the manager later in the week.

### SUMMARY

According to one embodiment, a method for generating a status report associated with at least one assigned task to at least one task owner is provided. The method may include querying the at least one task owner for at least one status data update associated with the at least one assigned task, wherein the querying is performed by a virtual personal assistant (VPA) associated with an on-line messaging environment. The method may also include recording the at least one status data update in a repository based on the querying by the VPA. The method may further include generating the status report based on the recorded at least one status data update.

According to another embodiment, a computer system for generating a status report associated with at least one assigned task to at least one task owner is provided. The computer system may include one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method. The method may include querying the at least one task owner for at least one status data update associated with the at least one assigned task, wherein the querying is performed by a virtual personal assistant (VPA) associated with an on-line messaging environment. The method may also include recording the at least one status data update in a repository based on the querying by the VPA. The method may further include generating the status report based on the recorded at least one status data update.

According to yet another embodiment, a computer program product for system for generating a status report associated with at least one assigned task to at least one task owner is provided. The computer program product may include one or more computer-readable storage devices and program instructions stored on at least one of the one or more tangible storage devices, the program instructions executable by a processor. The computer program product may also include program instructions to query the at least one task owner for at least one status data update associated with the at least one assigned task, wherein the querying is performed by a virtual personal assistant (VPA) associated with an on-line messaging environment. The computer program product may further include program instructions to record the at least one status data update in a repository based on the querying by the VPA. Additionally, the computer program product may include program instructions to generate the status report based on the recorded at least one status data update.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 illustrates a networked computer environment with an exemplary virtual personal assistant (VPA) associated with an on-line messaging environment according to one embodiment;

FIG. 3 is an operational flowchart illustrating the steps carried out by a program for a virtual personal assistant (VPA) associated with an on-line messaging environment according to at least one embodiment;

FIG. 4 is an operational flowchart illustrating the steps carried out by a program for a virtual personal assistant (VPA) associated with an on-line messaging environment according to at least one embodiment; and

FIG. 5 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly to real time communications. The following described exemplary embodiments provide a system, method and program product for a virtual personal assistant associated with an on-line messaging environment.

As previously described, regular status report updates are becoming a more common occurrence in the workplace. The regular status report, such as a weekly status report, may be a team management and productivity tool that increases communication between managers and their teams. The weekly status report may allow team members to report to the manager on important elements in the workplace such as progress against goals, current and upcoming focus areas, potential roadblocks to success, and any other employee perspectives or commentary that improves a manager's ability to manage. However, weekly status reporting may be time consuming and burdensome not only for the team member, but for the manager as well. A manager may use email to communicate and obtain status report updates from their team members. However, users (i.e., team members) may rely on chat windows associated with an on-line messaging environment as a preferred method to communicate rather than communicating via email. Therefore, a manager may select to use a chat window to collect status data. However, since the manager may have to communicate very frequently to collect the status data, such a task may become burdensome. Therefore, it may be beneficial to have a chat window with a virtual personal assistant (VPA) available to collect status data. As such, it may be advantageous, among other things, to provide a virtual personal assistant (VPA) via an on-line chat window that may always be available to collect status data from the team members, consolidate such status data, and report the consolidated status data to the manager.

According to at least one implementation, instant-messaging integration with task management tools may be utilized as a solution for task and workflow management. Embodiments of the present invention may define tasks for a user (i.e., a task owner). Then based on the defined tasks, an instant-messaging integration with task management tools may be utilized to perform follow-up, such as collecting timely feedback from the user. For example, according to present embodiments, an existing reminder system may be implemented where the task manager may set reminders in a real time communication system, such as an instant messaging system. Then, based on the pre-defined reminders, the task owner may receive an alert in the real time communication system which may correspond to the task or workflow item. As such, the task owner may respond timely and provide timely status data updates via the real time communication system. This may be more time efficient than a user simply setting a reminder and responding via email. A reminder may be “snoozed” by the user and the user is required to compose an email with the status updates which may be more time consuming than responding instantaneously via a chat window when the chat window appears with the reminder notification.

According to at least one embodiment, a superior, such as a task manager, may define a task and assign the task to an assignee (i.e., the task owner). However, after the initial assignment of the task by the task manager to the task owner, a virtual personal assistant (VPA) available via a real-time communication system, such as instant messaging, may be responsible for collecting the status data updates pertaining to the tasks (i.e., the responses from the team members who were assigned the tasks). Furthermore, the VPA may generate a report based on the consolidation of the responses from the team members who were assigned the tasks. As such, the feedback from the team members assigned the tasks may be timely. Additionally, having the VPA collect responses, consolidate the responses and generate the status report may alleviate the manager from having to perform such burdensome and time consuming tasks. For example, a manager may not have to follow-up with an individual, such as sending a follow-up email to retrieve status data updates. Also, the manager may not have to consolidate the status data updates and generate a report based on the consolidation of status data updates.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for a virtual personal assistant (VPA) associated with an on-line messaging environment. Currently, a user (i.e., task owner) may receive a repeatable TO-DO (i.e., an action item) that allows a user to receive timely reminders that remind the user to provide task updates and description updates. However, a user may snooze the reminder and as such, fail to provide timely updates. Additionally, a TO-DO may require a user to define a TO-DO task and after receiving the TO-DO reminder, a user may have the additional task of composing an email or initiating a chat via an online messaging system in order to report the status updates to the task manager. According to at least one implementation of the present embodiment, a VPA may be integrated into an instant messaging system, which may alert the user in real-time by sending an instant message that requests a status update pertaining to the task assigned to the user. The instant message may prompt the user to answer more timely than a simple reminder from the TO-DO since the user may be able to provide the status update more easily and conveniently by responding immediately to the chat window. For example, if a task manager needs to collect weekly status updates from task owners, the task manager may define a task named “Weekly Status Report” for all his team members (i.e., task owners). The task manager may also define the day and time each week that the task manager needs to receive feedback. As such, according to one implementation, the VPA may contact the task owner daily for status data updates via an instant messaging system. Then the VPA may consolidate the daily status data updates and generate a report which may be sent via the VPA to the task manager at the end of every week. Additionally, a level of intelligence may be added to the VPA. As such, the VPA may be able to receive inputs from a task management system or workflow management system in order to collect the timely feedback and generate the report for the task manager. Furthermore, the VPA system may be able to decide whether to remind a task owner via email or via a chat. Additionally, according to one implementation, the VPA system may be able to analyze the end user's (i.e., the task owner's) frequency of activity with respect to using an on-line messaging service for a certain period of time. As such, the VPA may determine a pattern of reminders, such as how early a reminder should begin or how often a reminder should occur. Also, the frequency of defaulters (i.e., users who fail to respond timely) may be monitored. As such, the delays in response by chat or email may be maintained and utilized in determining when and in what form a reminder may be sent to a user. For example, a user who is a defaulter for more than 10-20% may receive reminders from email. However, if the same user was a defaulter again for more than 10-20%, then the user may receive a reminder email and the user's manager may be copied on the email.

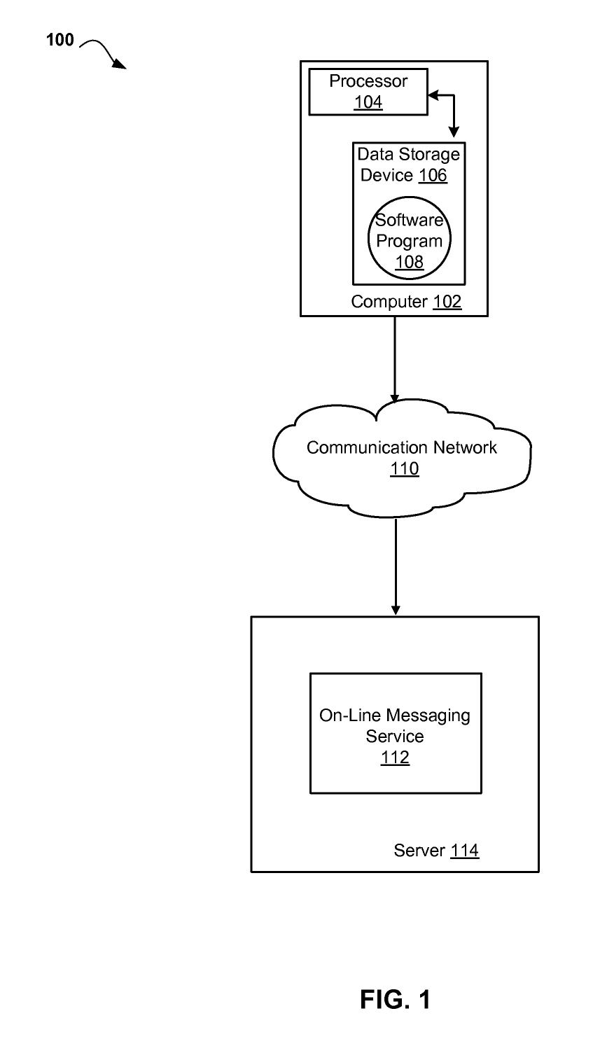

Referring now to FIG. 1, an exemplary networked computer environment 100 in accordance with one embodiment is depicted. The networked computer environment 100 may include a computer 102 with a processor 104 and a data storage device 106 that is enabled to run a software program 108. The networked computer environment 100 may also include an on-line messaging service, a server 114 and a communication network 110. The networked computer environment 100 may include a plurality of computers 102 and servers 114, only one of which is shown for illustrative brevity. The communication network may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

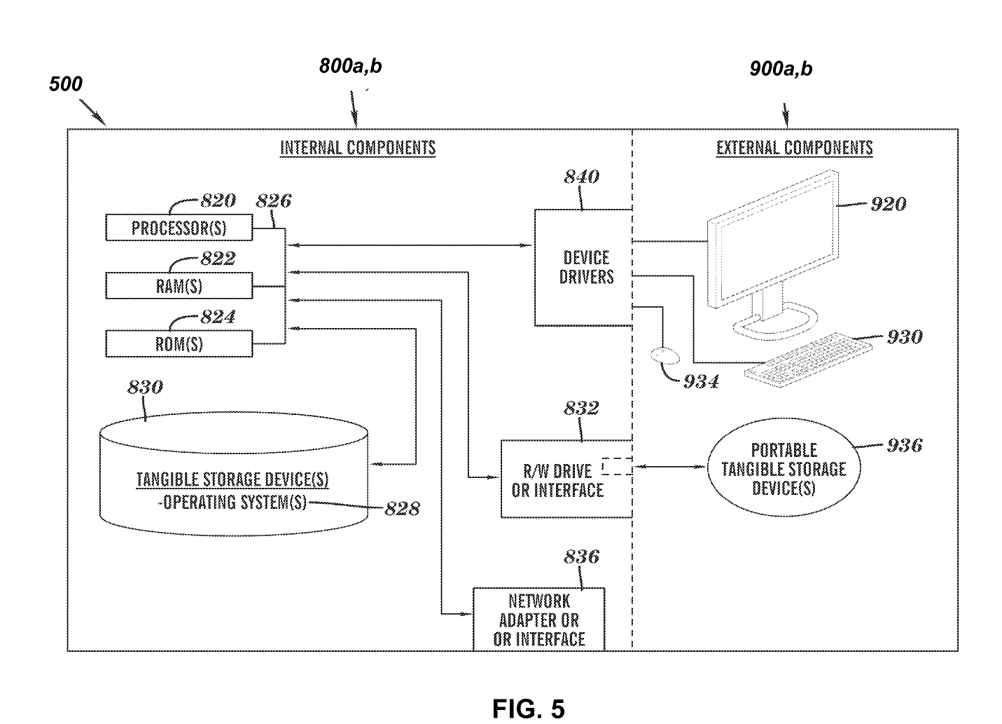

The client computer 102 may communicate with the on-line messaging service 112 running on server computer 114 via the communications network 110. The communications network 110 may include connections, such as wire, wireless communication links, or fiber optic cables. As will be discussed with reference to FIG. 5, server computer 114 may include internal components 800a and external components 900a, respectively and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing device capable of running a program, accessing a network, or accessing an on-line messaging service.

The client computer 102 may access online-messaging service 112, running on server computer 114 via the communications network 110. For example, a user using an application program 108 (e.g., Firefox®) (Firefox and all Firefox-based trademarks and logos are trademarks or registered trademarks of Mozzilla and/or its affiliates) running on a client computer 102 may connect via a communication network 110 to one of the user's on-line messaging services 112 which may be running on server computer 114.

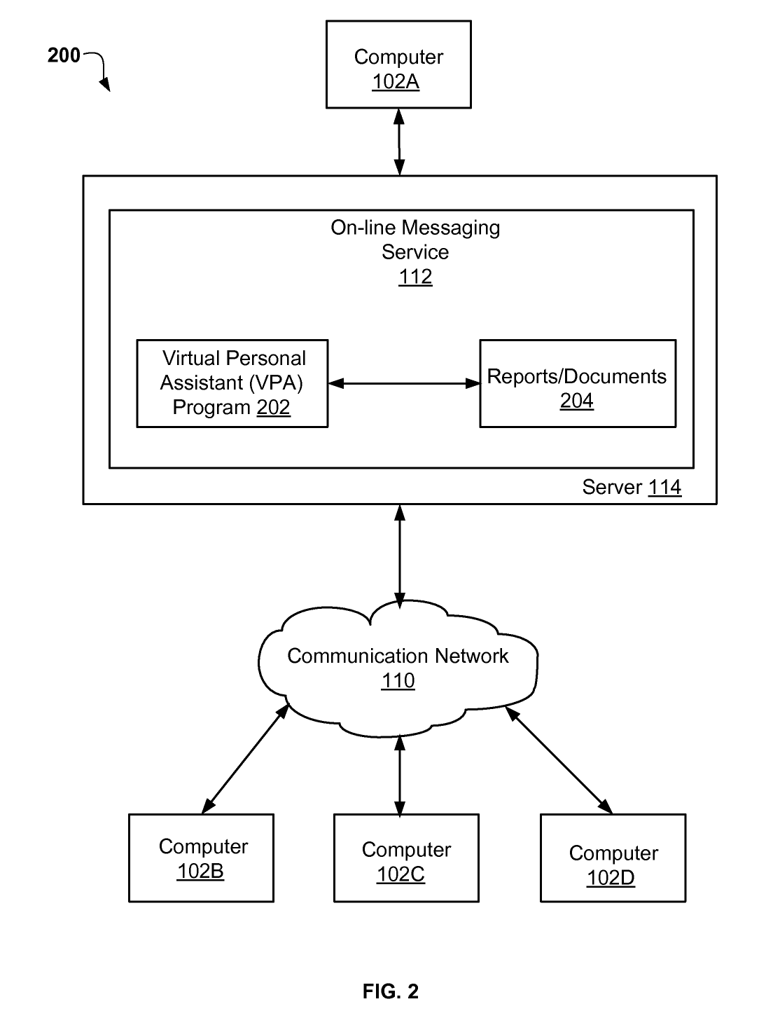

Referring now to FIG. 2, a networked computer environment 200 with an exemplary personal assistant program (VPA) 202 and a reports/document repository (i.e., database) 204 associated with an on-line messaging environment in accordance with one embodiment is depicted. VPA program 202 may be implemented as running on a server 214, a computer 102A-102D, or any type of computing device capable of running a program, accessing a network, or accessing an on-line messaging service. However, for example purposes only, VPA program 202 is depicted as running on server 214. Client computer 102A may communicate via a communication network 110 with an on-line messaging service 112 which may be running on a server computer 114. According to at least one implementation, an on-line messaging service running a VPA program 202 may enable a manager (i.e., task manager) using a computer 102A to define a task and configure various features pertaining to the task, such as the rules and a schedule. The rules and schedule may then be applied to all the task owners (i.e., users) in a group of users, where each person in the group may be using a computer 102B-102D and each user in the group may need to be queried for their status updates. As such, a virtual personal assistant (VPA) program 202 may be implemented as a program that may perform automated tasks, such as a BOT. Furthermore, the VPA interface may be available in a user's contact list associated with an on-line messenger service.

Additionally, according to at least one embodiment, the VPA framework associated with the VPA program 202 may allow a task manager using a computer 102A to design templates (i.e., forms) that may make it easier for the task manager to define the structure of the updates that the task manager may need to receive from each end user (i.e., task owner). As such, the VPA program 202 may present a pre-defined form to the user via an on-line messaging service (e.g., instant messaging service) in order to receive the user's status updates. Then, status updates may be collected via known technology. According to one implementation, if a user is determined to be off-line and not logged into an on-line messaging service, then the VPA program 202 may generate an email and send the email to the user. If the user has not answered after a certain period of time, then another email may be sent with the user's manager copied on the email. However, if the user replies, the response may be recorded by the VPA program 202. The VPA program may consolidate the various responses received from each team member (i.e., task owner) into a single document or report 204 for the manager to review. According to one embodiment, the document or report 204 may be saved as a wiki entry available for the task manager and team (i.e., group of task owners) to review, share and discuss.

According to at least one implementation, a structured template may be implemented for collecting the responses from the task owners. Therefore, using existing technology, the responses received from the task owners and the conversations between the VPA 202 and the task owners may be extracted. Then, a report 204 may be generated and the report 204 may be sent to the task manager. The report database 204 may provide a comprehensive automated status report that has consolidated the various status updates received from the task owners into a single document that may be sent and reviewed by the task manager.

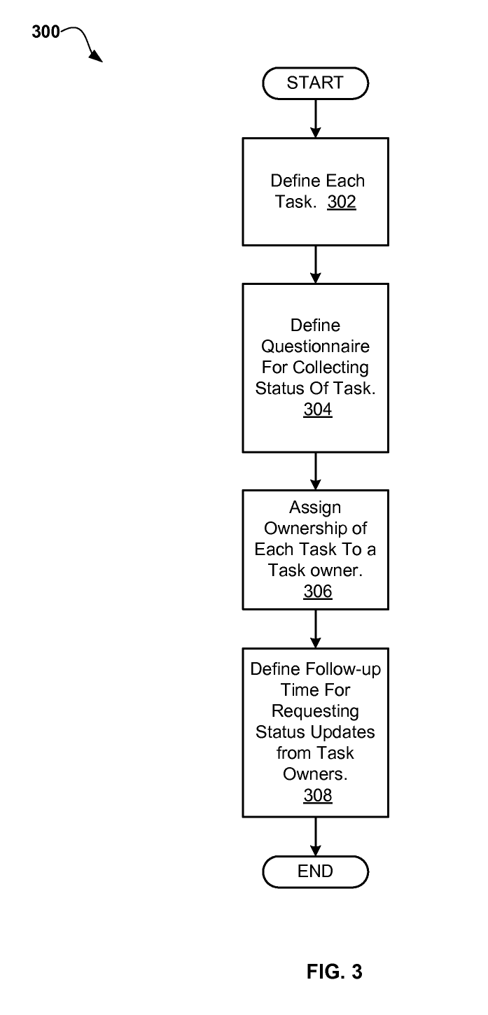

Referring now to FIG. 3, an operational flowchart 300 illustrating the steps carried out by a program for a virtual personal assistant (VPA) associated with an on-line messaging environment according to at least one embodiment is depicted. As previously described, an on-line messaging service running a VPA program 202 may enable a manager (i.e., task manager) using a computer 102A to define a task and configure various features pertaining to the task, such as the rules and a schedule. The rules and schedule may then be applied to all the task owners (i.e., users) in a group of users, where each person in the group may be using a computer 102B-102D and each user in the group may be queried for their status updates by the VPA 202. For example, if a task manager needs to collect weekly status updates from task owners, the task manager may define a task named “Weekly Status Report” for all the task manager's team members (i.e., task owners). The task manager may also define the day and time each week that the task manager may need to receive feedback.

With respect to FIG. 3, at 302, the task manager may define each task. According to one implementation, the task manager may utilize a template form to define specific settings associated with each task. As such, the task manager may consider each task and the activities related to the tasks, such as a task deadline.

Next, at 304, a questionnaire may be defined to aide in the collecting of status data for the defined task. According to one implementation, the questionnaire may be in the form of a decision tree. For example, a manager may define a questionnaire in the form of a decision tree such as the following:

Q1. What is the status of <Task>?

### C—Complete; I—In Progress; N—Not Started

Descriptive text (optional)—<description for Q1>
Depending on the answer of Q1, if it is I or N, VPA can ask
Q2. Are you on schedule for <Task>?

### Y—Yes; N—No

Descriptive text (required if Ans is N)—<description for Q2>
Q3. What is the plan for next week OR next day?
Descriptive text (required)—<description for Q3>

Therefore, depending the on the answer of current question, a next question may be shown. As such, the questionnaire may have its own decision tree logic in place and validation of the responses by the task owner may be checked by comparing the answers to pre-determined criteria (i.e., rules). According to at least one implementation, the pre-determined rules may define that the required responses may not be left blank. Additionally, there may be a rule for a minimum amount of words. Also, using existing text analysis tools, unstructured text may be analyzed using a knowledge base/rules engine.

Then, at 306, the task manager may assign each task to a task owner. Therefore, based on the defining of the task, the task manager may assign the defined task to a task owner. As such, the task owner may be responsible for the specific task that was assigned to them.

Next, at 308, the task manager may define a follow-up time schedule, such as weekly reminders, for the VPA to request status updates from the assigned task owners. The follow-up schedule may be based on the defining of the questionnaire. As previously described, a structured template (i.e., a questionnaire) may be implemented for collecting the responses from the task owners. Therefore, using existing technology, the responses received from the task owners and the conversations between the VPA 202 (FIG. 2) and the task owners may be extracted and a report 204 (FIG. 2) may be generated and the report 204 (FIG. 2) may be sent to the task manager. The report database (i.e., repository) 204 (FIG. 2) may provide a comprehensive automated status report that has consolidated the various status updates received from the task owners into a single document that may be sent and reviewed by the task manager.

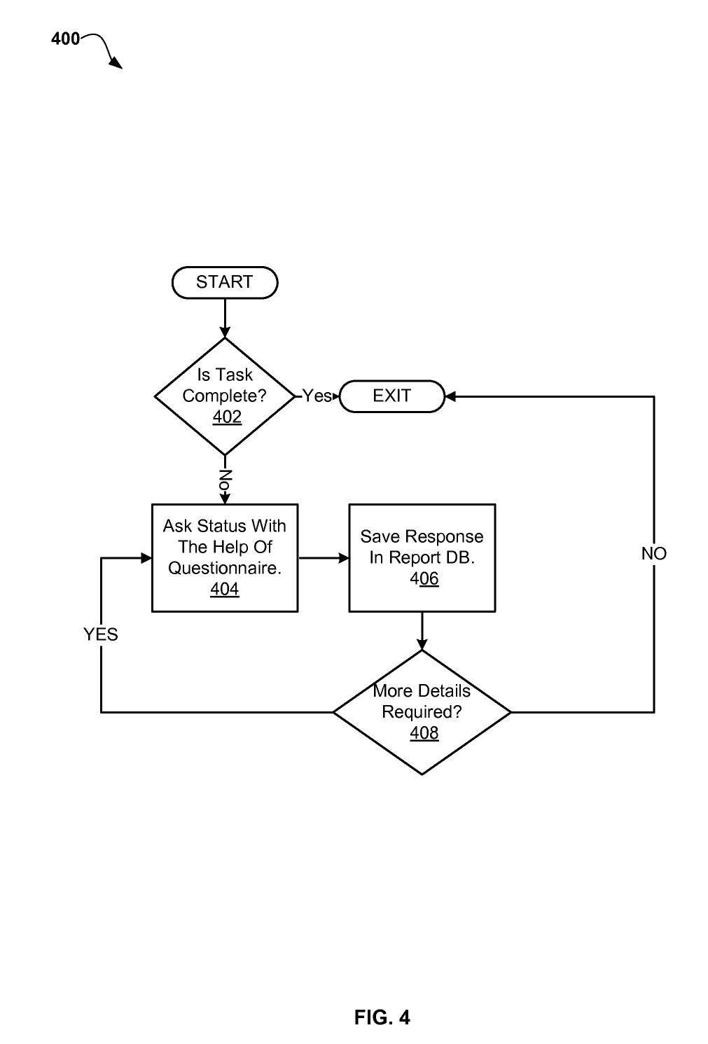

Referring now to FIG. 4, an operational flowchart 400 illustrating the steps carried out by a program for a virtual personal assistant (VPA) associated with an on-line messaging environment according to at least one embodiment is depicted. According to at least one implementation, known technology may be used to collect status reports from a conversation between the VPA and the task owner. Therefore the VPA may be online and available via an online messenger service that is utilized by the task owner. As such the VPA may use the online messenger service to request status data updates regarding task that were assigned to the task owner. Then, based on the follow-up schedule that was determined with respect to the method previously described in FIG. 3, the VPA may contact the task owner. For example, the VPA may contact a task owner daily for status data updates via an instant messaging system.

With respect to FIG. 4, at 402, it may be determined as to whether a task has been completed. For example, the VPA may query the task owner to determine whether the specific task assigned to the task owner has been completed. If at 402, the task has been completed, then the program may terminate and using existing technology, a report may be generated for the manager based on the saved responses in the Status Report database (i.e., a repository) 204 (FIG. 2).

However, if at 402, the task has not been completed, then at 404, the VPA, via an online messaging service, may request status from the task owner regarding the specific task that was assigned to the task owner. As such, the VPA may query a task owner for at least one status data update associated with at least one assigned task to the task owner. The request may be implemented based on the defined questionnaire. As previously described with respect to FIG. 3, a manager may define a questionnaire in the form of a decision tree and depending the on the answer of current question, a next question may be shown.

Then, at 406, the response may be saved in a report database (i.e. a repository). As such, the status data updates (i.e., responses) may be recorded in the Status Report database (i.e., repository) 204 (FIG. 2) to aide in the generation of reports for the task manager. Next, at 408, the VPA may determine whether more details are required from the task owner. If at 408, it is determined that more details are required from the task owner, then the program may return to step 404 and the VPA, via an online messaging service, may request status from the task owner regarding the specific task that was assigned to the task owner.

If at 408, it is determined that no more details are required from the task owner, then the program may terminate and using existing technology, a report may be generated for the manager based on the saved responses in the Status Report database (i.e., repository) 204 (FIG. 2). As such, a status report may be generated based on the recorded status updates in the repository. For example, the VPA may consolidate the daily status data updates and generate a report which may be sent via the VPA to the task manager at the end of every week.

FIG. 5 is a block diagram 500 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 114 (FIG. 1) may include respective sets of internal components 800 a, b and external components 900 a, b illustrated in FIG. 5. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and software program 108 (FIG. 1) in client computer 102 are stored on one or more of the respective computer-readable tangible storage devices 830 for execution by one or more of the respective processors 820 via one or more of the respective RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program 108, such as virtual personal assistant (VPA) program 202, can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The software program 108 in client computer 102 and virtual personal assistant (VPA) program 202 in network server 114 can be downloaded to client computer 102 from an external computer via a network (for example, the Internet, a local area network or other, wide area network) and respective network adapters or interfaces 836. From the network adapters or interfaces 836, the software program 108 in client computer 102 and the virtual personal assistant (VPA) program 202 in network server computer 114 are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1.-7. (canceled)

8. A computer system for generating a status report associated with at least one assigned task to at least one task owner, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
querying the at least one task owner for at least one status data update associated with the at least one assigned task, wherein the querying is performed by a virtual personal assistant (VPA) associated with an on-line messaging environment;
recording the at least one status data update in a repository based on the querying by the VPA; and
generating the status report based on the recorded at least one status data update.

9. The computer system of claim 8, further comprising:
defining the at least one assigned task;
defining a questionnaire for the at least one assigned task based on the defining of the at least one task;
assigning the at least one assigned task to the at least one task owner, wherein the assigning is based on the defining of the at least one assigned task; and
defining a follow-up schedule based on the defining of the questionnaire.

10. The computer system of claim 8, wherein the status report is generated by the virtual personal assistant (VPA).

11. The computer system of claim 9, wherein the defining of the at least one assigned task; the defining of the questionnaire; and the defining of the follow-up schedule is performed by a task manager.

12. The computer system of claim 9, wherein the querying is based on the questionnaire.

13. The computer system of claim 9, wherein the querying is based on the follow-up schedule.

14. The computer system of claim 9, wherein the questionnaire configures at least one rule associated with the at least one assigned task.

15. A computer program product for generating a status report associated with at least one assigned task to at least one task owner, the computer program product comprising:
one or more computer-readable storage devices and program instructions stored on at least one of the one or more tangible storage devices, the program instructions executable by a processor, the program instructions comprising:
program instructions to query the at least one task owner for at least one status data update associated with the at least one assigned task, wherein the querying is performed by a virtual personal assistant (VPA) associated with an on-line messaging environment;
program instructions to record the at least one status data update in a repository based on the querying by the VPA; and
program instructions to generate the status report based on the recorded at least one status data update.

16. The computer program product of claim 15, further comprising:
program instructions to define the at least one assigned task;
program instructions to define a questionnaire for the at least one assigned task based on the defining of the at least one task;
program instructions to assign the at least one assigned task to the at least one task owner, wherein the assigning is based on the defining of the at least one assigned task; and
program instructions to define a follow-up schedule based on the defining of the questionnaire.

17. The computer program product of claim 15, wherein the status report is generated by the virtual personal assistant (VPA).

18. The computer program product of claim 16, wherein the defining of the at least one assigned task; the defining of the questionnaire; and the defining of the follow-up schedule is performed by a task manager.

19. The computer program product of claim 16, wherein the querying is based on the questionnaire.

20. The computer program product of claim 16, wherein the querying is based on the follow-up schedule.
